(19) United States
(12) Patent Application Publication
(10) Pub. No.: US 2003/0113580 A1
(43) Pub. Date: Jun. 19, 2003

(54) Preparation of radiation image storage panel

(75) Inventors: Atsunori Takasu, Ashigara-kami-gun (JP); Hiroshi Matsumoto, Ashigara-kami-gun (JP); Makoto Kashiwaya, Odawara-shi (JP)

Correspondence Address: SUGHRUE MION, PLLC, 2100 Pennsylvania Avenue, N.W., Washington, DC, 20037-3213, US

(73) Assignee: FUJI PHOTO FILM CO., LTD.

(21) Appl. No.: 10/206,956

(22) Filed: Jul. 30, 2002

(30) Foreign Application Priority Data
Jul. 30, 2001 (JP) 2001-229593
Jul. 30, 2001 (JP) 2001-229594

(51) Int. Cl. G21K 4/00; G01N 21/00; G01N 23/00; B05D 1/00

(52) U.S. Cl. 428/690; 427/157; 427/248.1; 250/484.4

(57) ABSTRACT

A method for preparing a radiation image storage panel by heating an evaporation source of phosphor material or starting materials for the phosphor material under reduced pressure to produce a vapor of the phosphor material or starting materials and deposit the vapor on a substrate to form a phosphor layer is favorably performed by using an evaporation source having a water content of not more than 0.5 weight %, preferably under the conditions of a partial pressure of water of 7.0×10⁻³ Pa or lower and a partial pressure of hydrocarbon of 1.0×10⁻⁶ Pa or lower.

### FIELD OF THE INVENTION

The invention relates to a method for preparing a radiation image storage panel favorably employable in a radiation image recording and reproducing method utilizing stimulated emission of a stimulable phosphor.

### BACKGROUND OF THE INVENTION

When the stimulable phosphor is exposed to radiation such as X-rays, it absorbs and stores a portion of the radiation energy. The stimulable phosphor then emits stimulated emission according to the level of the stored energy when the phosphor is exposed to electromagnetic wave such as visible light or infrared rays (i.e., stimulating light).

A radiation image recording and reproducing method utilizing the stimulable phosphor has been widely employed in practice. The method employs a radiation image storage panel comprising the stimulable phosphor, and comprises the steps of causing the stimulable phosphor of the storage panel to absorb radiation energy having passed through an object or having radiated from an object; sequentially exciting the stimulable phosphor with a stimulating light to emit stimulated light; and photo-electrically detecting the emitted light to obtain electric signals giving a visible radiation image. The storage panel thus treated is subjected to a step for erasing radiation energy remaining therein, and then stored for the use in the next recording and reproducing procedure. Thus, the radiation image storage panel can be repeatedly used.

The radiation image storage panel (often referred to as stimulable phosphor sheet) has a basic structure comprising a substrate and a stimulable phosphor layer provided thereon.

The phosphor layer is generally formed by coating a dispersion of phosphor particles in a binder solution on the substrate and drying the coated dispersion on the substrate, and therefore comprises a binder and phosphor particles dispersed therein.

It is desired that radiation image storage panels used in these methods have sensitivity as high as possible.

It is known that a radiation image storage panel having on a substrate a stimulable phosphor film prepared by vapor deposition (or vapor-accumulating method) such as vacuum vapor deposition or sputtering gives a reproduced radiation image with high sensitivity as well as high sharpness.

Japanese Patent Provisional Publication No. 62-47600 discloses a method in which a stimulable phosphor film of a radiation image storage panel is formed by electron beam evaporation (which is a kind of vapor deposition method). In the method, an electron beam generated by an electron gun is applied onto a stimulable phosphor or its starting materials (i.e., evaporation source) to heat and vaporize the source, to deposit the vapor to form a phosphor film on the surface of the substrate. Thus formed phosphor film consists essentially of prismatic crystals of the stimulable phosphor. In the phosphor film, there are cracks among the prismatic crystals of the stimulable phosphor. For this reason, the stimulating rays are efficiently applied to the phosphor and the stimulated emission are also efficiently taken out. Hence, a radiation image of high sharpness can be obtained with high sensitivity.

Japanese Patent Publication No. 6-77079 describes a radiation image storage panel in which a stimulable phosphor film is formed by vapor deposition to have a fine block structure.

Japanese Patent Provisional Publication No. 63-158500 describes the preparation of a phosphor layer by deposition using a compressed evaporation source. The publication discloses that the compression can be performed under reduced pressure and/or with heating and the compressed evaporation source can be preferably heated to reduce an air content and a water content of the evaporation source. However, no detailed description is given in the publication.

Japanese Patent No. 3,070,939 describes that a phosphor layer is prepared by vapor deposition under the condition that an atmospheric pressure is increased.

WO 200103156 describes that a phosphor layer of stimulable CsX:Eu phosphor is produced by vapor deposition.

In any publications, there is given no description with respect to a partial pressure of water in the surrounding atmosphere in the vapor deposition procedure.

### SUMMARY OF THE INVENTION

The present invention has an object to provide a method for preparing a radiation image storage panel which shows high sensitivity.

The present inventors have noted that the water content of the evaporation source severely affects the conditions of the phosphor layer formed by the vapor deposition and therefore affects the image quality of the reproduced radiation image provided by a radiation image storage panel having the formed phosphor layer.

The inventor also have noted that a partial pressure of water and/or hydrocarbon in the surrounding atmosphere in the procedure of vapor deposition severely affects the conditions of the phosphor layer formed by the vapor deposition and therefore affects the image quality of the reproduced radiation image provided by a radiation image storage panel having the formed phosphor layer.

The inventor further have noted that the content of an alkali metal and an alkaline earth metal in the deposited phosphor layer severely affects the conditions of the phosphor layer formed by the vapor deposition and therefore affects the image quality of the reproduced radiation image provided by a radiation image storage panel having the formed phosphor layer.

The above-mentioned problems are particularly noted when the phosphor contains an europium element.

Accordingly, the present invention resides in a method-I for preparing a radiation image storage panel by heating an evaporation source comprising phosphor material or starting materials for the phosphor material under reduced pressure to produce a vapor of the phosphor material or starting materials and deposit the vapor on a substrate to form a phosphor layer thereon, wherein the evaporation source has a water content of not more than 0.5 weight %.

The invention further resides in a method for preparing a radiation image storage panel by heating a evaporation source comprising phosphor material or starting materials for the phosphor material under reduced pressure to produce a vapor of the phosphor material or starting materials and deposit the vapor on a substrate to form a phosphor layer thereon, wherein the production and deposition of vapor are performed at a partial pressure of water of 7.0×10⁻³ Pa or lower.

The invention furthermore resides in a method for preparing a radiation image storage panel by heating a evaporation source comprising phosphor material or starting materials for the phosphor material under reduced pressure to produce a vapor of the phosphor material or starting materials and deposit the vapor on a substrate to form a phosphor layer thereon, wherein the production and deposition of vapor are performed at a partial pressure of hydrocarbon of 1.0×10⁻⁶ Pa or lower.

### DETAILED DESCRIPTION OF THE INVENTION

In the invention, a stimulable phosphor is preferably employed. Particularly preferred is an alkali metal halide phosphor having the formula (I):

M^{I}X.aM^{II}X′₂.bM^{III}X″₃:zA (I)

in which M^{I} is at least one alkali metal element selected from the group consisting of Li, Na, K, Rb and Cs; M^{II} is at least one alkaline earth metal element or divalent metal element selected from the group consisting of Be, Mg, Ca, Sr, Ba, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Lu, Al, Ca and In; each of X, X′ and X″ independently is at least one halogen selected from the group consisting of F, Cl, Br and I; A is at least one rare earth element or metal element selected from the group consisting of Y, Ce, Pr, Nd, Sm, Eu, Gd, Tb, Dy, Ho, Er, Tm, Yb, Lu, Na, Mg, Cu, Ag, Tl and Bi; and a, b and z are numbers satisfying the conditions of 0 a<0.5, 0b<0.5 and 0<z<1.0, respectively. the following embodiments are preferred.

The preparation of a radiation image storage panel of the invention is described below by referring to the above-mentioned stimulable phosphor.

The vaporization of the evaporation source and deposition of the produced vapor can be performed in a vacuum evaporation apparatus comprising a vacuum chamber equipped with a vacuum pump, a supporting plate for evaporation source, heating means, and a supporting means for a substrate on which the vapor is to be deposited.

For performing the vacuum evaporation, the evaporation source is placed directly on the supporting plate or placed in a crucible or dish which is then placed on the supporting plate. A number of evaporation sources can be employed in the vacuum evaporation. The substrate is attached to the supporting means in the position over the evaporation source.

The substrate preferably are sheets of quartz glass, sapphire, metals (e.g., aluminum, iron, tin, chromium) or heat-resistant resins (e.g., aramide). On the substrate can be placed a light reflecting layer such as a layer containing a titanium dioxide or a light absorbing layer such as a layer containing carbon black.

On the substrate, a phosphor film is deposited. The phosphor film is preferably formed by electron beam deposition which employs electron beam to heat the evaporation source. The electron beam evaporation gives regularly aligned prismatic crystals having good shape.

The phosphor preferably is a stimulable phosphor which emits a stimulated emission having a wavelength of 300 to 500 nm when it is irradiated with a stimulating light having a wavelength of 400 to 900 nm.

Preferred is an alkali metal halide phosphor having the formula (I):

M^{I}X.aM^{II}X′₂.bM^{III}X″₃:zA (I)

in which M^{I} is at least one alkali metal element selected from the group consisting of Li, Na, K, Rb and Cs; M^{II} is at least one alkaline earth metal element or divalent metal element selected from the group consisting of Be, Mg, Ca, Sr, Sa, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ independently is at least one halogen selected from the group consisting of F, Cl, Br and I; A is at least one rare earth element or metal element selected from the group consisting of Y, Ce, Pr, Nd, Sm, Eu, Gd, Tb, Dy, Ho, Er, Tm, Yb, Lu, Na, Mg, Cu, Ag, Tl and Bi; and a, b and z are numbers satisfying the conditions of 0≦a<0.5, 0≦b<0.5 and 0<z<1.0, respectively.

In the formula (I), at least Cs is preferably included as M^{I}, at least Br is preferably included as X, and A is particularly preferably Eu or Bi. The phosphor of the formula (I) may contain a metal oxide (such as aluminum oxide, silicon dioxide or zirconium oxide) as an additives in an amount of not more than 0.5 mol based on 1 mol of M^{I}.

Another preferred stimulable phosphor is a rare earth activated alkaline earth metal fluoride-halide phosphor having the following formula (II):

M^{II}FX:zLn (II)

in which M^{II} is at least one alkaline earth metal element selected from the group consisting of Ba, Sr and Ca; Ln is at least one rare earth element selected from the group consisting of Ce, Pr, Sm, Eu, Tb, Dy, Ho, Nd, Er, Tm and Yb; X is at least one halogen selected from the group consisting of Cl, Br and I; and z is a number satisfying the condition of 0<z≦0.2.

In the formula (II), Ba is preferably included in an amount of half or more of M^{II}, and Ln particularly preferably is Eu or Ce. The M^{II}FX in the formula (II) indicates the crystal structure of BaFX, and it by no means indicates F:X=1:1. The formula (II), therefore, does not indicate resultant stoichiometric composition. It is generally preferred to produce many F⁺(X⁻) centers (which are vacant lattice points of X⁻ ion) in a BaFX crystal, so as to enhance the efficiency of emission stimulated by light in the wavelength region of 600 to 700 nm. In many cases, F is in slight excess of X.

One or more of the following additives may be added into the phosphor of the formula (II), if needed, although they are omitted in the formula (II):

bA, wN^{I}, xN^{II}, yN^{III}

In the above formula, A is a metal oxide such as Al₂O₃, SiO₂ or ZrO₂. For preventing M^{II}FX particles from sintering, A is preferably inactive to M^{II}FX and is preferably in the form of fine particles (the mean size of primary particles is not more than 0.1 μm). N^{I} is a compound of at least one alkali metal element selected from the group consisting of Li, Na, K, Rb and Cs; N^{II} is a compound of alkaline earth metal element Mg and/or Be; and N^{III} is a compound of at least one trivalent metal element selected from the group consisting of Al, Ga, In, Tl, Sc, Y, La, Gd and Lu.

The letters b, w, x and y represent added amounts of the additives, based on 1 mol of M^{II}FX when the additives are added into the phosphor. They satisfy the conditions of 0≦b≦0.5, 0≦w≦2, 0≦x≦0.3 and 0≦y≦0.3. The amounts of the additives often decrease during sintering and washing processes, and hence the b, w, x and y do not always indicate the ratios of the components in the resultant phosphor. Some of the additives are not changed to remain in the resultant phosphor, but others are reacted with or incorporated in M^{II}FX.

Further, other additives can be added to the phosphor of the formula (II), if needed. Examples of the additives include Zn and Cd compounds; metal oxides such as TiO₂, BeO, MgO, CaO, SrO, BaO, ZnO, Y₂O₃, La₂O₃, In₂O₃, GeO₂, SnO₂, Nb₂O₅, Ta₂O₅ and ThO₂; Zr and Sc compounds; B compounds; As and Si compounds; tetrafluoroborates; hexafluoro compounds (monovalent or divalent salts of hexafluorosilicate, hexafluorotitanate and hexafluorozirconate); and compounds of transition metal such as V, Cr, Mn, Fe, Co and Ni. Further, whether the above additives are incorporated or not, any rare earth activated alkaline earth metal fluorohalide stimulable phosphor can be used in the invention.

The phosphor used in the invention is not restricted to a stimulable phosphor. A phosphor giving a spontaneous emission in the ultraviolet or visible wavelength region when it absorbs a radiation such as X-ray can be also employed in the invention. Examples of these phosphors include LnTaO₄: (Nb,Gd), Ln₂SiO₅:Ce, LnOX:Tm (where Ln is a rare earth element), CsX (where X is a halogen), Gd₂O₂S :Tb, Gd₂O₂S:Pr,Ce, ZnWO₄, LuAlO₃:Ce, Gd₃Ga₅O₁₂:Cr, Ce and HfO₂.

In the case that the phosphor of the formula (I) contains an europium activator, the europium compound of the evaporation source preferably comprise a divalent europium (Eu²⁺) compound and a trivalent (Eu³⁺) compound. It is preferred that the europium compound contains the divalent europium compound as much as possible, at least 70%.

The evaporation source preferably is in the form of a tablet having a water content of not more than 0.5 weight %, preferably not more than 0.3 weight %. The water content can be determined by thermogravimetric analysis in which the weight loss in the temperature range of 50 to 150° C. is measured.

The evaporation source having a water content of not more than 0.5 wt. % can be produced by heat treatment under reduced pressure. The heat treatment can be performed at 100 to 300° C. Otherwise, the evaporation source having a water content of not more than 0.5 wt. % can be produced by heating an evaporation source under a dry surrounding atmosphere such as a nitrogen atmosphere until it fuses.

Moreover, the evaporation source preferably has a relative density of 80% or more, generally 90% or more. The relative density means a value obtained by dividing a density of the evaporation source by the inherent density of the corresponding material. For instance, 80% or more of the relative density means 3.5 g/cm³ or more for CsBr and 4.4 g/cm³ or more for EuBr₂. The evaporation source of a high relative density can be evaporated uniformly and then is effective to produce a deposited phosphor film (or layer) of a uniform thickness. The evaporation source such as that in the form of a tablet can be produced by compressing a powdery evaporation source at a pressure of 20 MPa or more, or by heating the powder until the powder fuses.

It is preferred that the evaporation source does not contains more than 10 ppm of alkali metal impurities and more than 5 ppm of alkaline earth metal impurities. The alkali metal impurities and alkaline earth metal impurities mean, respectively, alkali metals and alkaline earth metals other than the alkali metals and alkaline earth metals constituting the alkali metal halide phosphor of the formula (I) in the evaporation source.

The deposited phosphor film prepared by the use of an evaporation source containing almost no alkali metal impurities and almost no alkaline earth metal impurities shows an improved high emission luminance.

In the present invention, the phosphor layer is preferably formed by electron beam-evaporating method, which is a kind of vapor deposition method. The electron beam-evaporating method gives regularly aligned prismatic crystals having good shape.

For the preparation of the phosphor film on a substrate, it is preferred to employ two or more evaporation sources such as a combination of an evaporation source (such as in the form of tablet) comprising a mother component and an evaporation source (such as in the form of tablet) comprising an activator element. Plural evaporation sources comprising a mother component can be employed in the vaporization procedure. Plural evaporation sources comprising an activator element also can be employed in the vaporization procedure.

In the vacuum evaporation apparatus, the evaporation sources and a substrate on which the phosphor film is to be deposited are set. The substrate is placed perpendicularly to the direction in which the vapor comes out of the source. The apparatus is then evacuated to give an inner pressure of 1×10⁻⁵ to 1×10⁻² Pa. An inert gas such as Ar gas or Ne gas may be incorporated into the apparatus.

It is preferred that the evaporation procedure (that is, a combination of production and deposition of vapor) are performed in the vacuum chamber at a partial pressure of water of 7.0×10⁻³ Pa or lower. A partial pressure of water of 3.0×10⁻³ Pa or lower is more preferred. The partial pressure of water can be deter ed using a mass filter.

The low partial pressure of water in the vacuum chamber can be produced by the use of a combination of a diffusion pump (or a turbo-molecular pump) and a cold trap. Examples of the cold traps include a cryo coil, a cryo panel, and a super trap. The use of the combination of a diffusion pump and a cold trap is effective to selectively reduce the water content in the evaporation chamber. Otherwise, an active film such as Ti film can be deposited on the inner surface of wall of the chamber to adsorb a water vapor in the chamber. Also effective is to heat the inner surface to 110-150° C. to remove water adsorbed on the surface.

It is also preferred that the evaporation procedure (that is, a combination of production and deposition of vapor) are performed in the vacuum chamber at a partial pressure of hydrocarbon of 1.0×10⁻⁶ Pa or lower. The partial pressure of hydrocarbon is a value in terms of hydrocarbon of amu=55. It is not necessary to reduce the partial pressure of hydrocarbon 1.0×10⁻⁹ Pa or lower, because such a high vacuum condition can be made only by using a specifically designed vacuum system. The partial pressure of hydrocarbon can be determined using a mass filter.

The reduction of the partial pressure of hydrocarbon in the vacuum chamber can be accomplished by washing the inner members of the chamber with various solvents and heating the washed members before the evaporation chamber is used in the evaporation procedure. Examples of the solvents include acetone, an alcohol such as methanol, ethanol, or isopropyl alcohol, distilled water which can contain a surface active agent. Otherwise, the chamber is evacuated to reach a high vacuum condition before it is employed for the evaporation procedures. The reduction of a partial pressure of water and the reduction of a partial pressure of hydrocarbon can be accomplished simultaneously.

In the vacuum evaporation apparatus, an electron beam generated by an electron gun is applied onto the evaporation source(s). The accelerating voltage of electron beam preferably is in the range of 1.5 kV to 5.0 kV.

By applying the electron beam, the evaporation source is heated, vaporized, and deposited on the substrate. The deposition rate of the phosphor generally is in the range of 0.1 to 1,000 μm/min., preferably in the range of 1 to 100 μm/min. The electron beam may be applied twice or more to form multi-layered phosphor films. The substrate may be cooled or heated, if needed, during the deposition process, or may be subjected to heat treatment (annealing treatment) after the deposition process is complete.

The vacuum evaporation method is not restricted to the electron beam-evaporating method, and various methods such as resistance-heating method and sputtering method can be used.

In the above-described manner, the phosphor film in which the prismatic stimulable phosphor crystals are aligned almost perpendicularly to the substrate is formed. Thus formed phosphor film comprises only the stimulable phosphor with no binder, and there are produced cracks extending the depth direction in the phosphor film.

The phosphor film preferably has a thickness of 50 μm to 1 mm, more preferably 200 to 700 μm.

The produced phosphor film can be separated from the substrate and then placed on a different substrate.

It is preferred to place a transparent protective film on the surface of the deposited phosphor film, so as to ensure good handling of the radiation image storage panel in transportation and to avoid deterioration. The protective film preferably is transparent. Further, for protecting the storage panel from chemical deterioration and physical damage, the protective film preferably is chemically stable, physically strong, and of high moisture proof.

The protective film can be provided by coating the stimulable phosphor film with a solution in which an organic polymer (e.g., cellulose derivatives, polymethyl methacrylate, fluororesins soluble in organic solvents) is dissolved in a solvent, by placing a beforehand prepared sheet for the protective film (e.g., a film of organic polymer such as polyethylene terephthalate, a transparent glass plate) on the phosphor film with an adhesive, or by depositing vapor of inorganic compounds on the phosphor film.

Various additives may be dispersed in the protective film. Examples of the additives include light-scattering fine particles (e.g., particles of magnesium oxide, zinc oxide, titanium dioxide and alumina), a slipping agent (e.g., powders of perfluoroolefin resin and silicone resin) and a crosslinking agent (e.g., polyisocyanate). The thickness of the protective film generally is in the range of about 0.1 to 20 μm (it the film is made of polymer material) or in the range of about 100 to 1,000 μm (if the film is made of inorganic material such as silicate glass). For enhancing the resistance to stain, a fluororesin layer is preferably provided on the protective film. The fluororesin layer can be form by coating the surface of the protective film with a solution in which a fluororesin is dissolved or dispersed in an organic solvent, and drying the coated solution. The fluororesin may be used singly, but a mixture of the fluororesin and a film-forming resin can be employed. In the mixture, an oligomer having polysiloxane structure or perfluoroalkyl group can be further added. In the fluororesin layer, fine particle filler may be incorporated to reduce blotches caused by interference and to improve the quality of the resultant image. The thickness of the fluororesin layer is generally in the range of 0.5 to 20 μm. For forming the fluororesin layer, additives such as a crosslinking agent, a film-hardening agent and an anti-yellowing agent can be used. In particular, the crosslinking agent is advantageously employed to improve durability of the fluororesin layer.

Thus, the radiation image storage panel of the invention can be prepared. The storage panel of the invention may have known various structures. For example, in order to improve the sharpness of the resultant image, at least one of the films may be colored with a colorant which does not absorb the stimulated emission but the stimulating rays.

The present invention is further described by the following examples.

In the following examples, the water content of a sample was determined in a differential thermogravimetric simultaneous measurement analysis (TG/DTA 320 type, Seiko Electronic Industry Co., Ltd.) by measuring loss of weight of the sample at an increased temperature of room temperature to 300° C. at a temperature increase rate of 10° C./min., in a stream of nitrogen gas (200 cc/min.) according to thermogravimetry. The partial pressures of water (H₂O) and hydrocarbon (in terms of amu=55) were determined on the atmospheric gas using a remaining gas analyzer (Mass Filter, RGA 300, Stanford Research Systems Incorporated) according to mass spectroscopy. The vacuum level in the evaporation apparatus was measured by means of an ionization vacuum gauge (GI-TL3RY, Japan Vacuum Technology Co., Ltd.)

### EXAMPLE 1

(1) Starting Materials

Powdery cesium bromide (CsBr) and powdery europium bromide (EuBrₓ, x=2.2, purity: 3N or higher) were employed as the starting materials. The analysis of each starting material by ICP-MS method (inductively coupled plasma spectroscopy—mass spectroscopy) revealed that each of alkali metals other than Cs (Li, Na, K, Rb) and each of alkaline earth metals (Mg, Ca, Sr, Ba) were present in the cesium bromide in amounts of less than 10 ppm and less than 5 ppm, respectively, and each of rare earth elements other than Eu and each of other elements were present in the europium bromide in amounts of less than 20 ppm and less than 10 ppm, respectively.

Since both starting materials were highly hygroscopic, they were stored in a desiccator under dry atmosphere showing a dew point of lower than −20° C., and taken out just before the following preparation was made.

(2) Preparation of CsBr Evaporation Source

The powdery CsBr (31 g) was placed in a powder moulding zirconia die (inner diameter: 25 mm) and compressed in a powder moulding press (Tablepress TB-5 type, NPA System Co., Ltd.) at a pressure of 40 kN, to produce a tablet (diameter: 25 mm, thickness: 15 mm). The pressure applied to the powdery CsBr was approx. 80 MPa. The produced tablet had a density of 4.2 g/cm³, and a water content of 0.6 wt. %.

The tablet was dried in a vacuum drying apparatus at 200° C., for 2 hours. The dried table had a water content of 0.3 wt. %.

(3) Preparation of EuBrₓ Evaporation Source

The powdery EuBrₓ (x=2.2, 25 g) was placed in the powder moulding zirconia die and compressed in the powder moulding press at a pressure of 40 kN, to produce a tablet (diameter: 25 mm, thickness:.10 mm). The pressure applied to the powdery EuBrₓ was approx. 80 MPa. The produced tablet had a density of 5.1 g/cm³, and a water content of 0.8 wt. %.

The tablet was dried in a vacuum drying apparatus at 200° C., for 2 hours. The dried table had a water content of 0.5 wt. %.

(4) Formation of Phosphor Film

A synthetic quartz substrate was washed successively with an aqueous alkaline solution, purified water, and isopropyl alcohol, and then mounted to a substrate holder within an evaporation apparatus. In the apparatus, the CsBr tablet and EuBrₓ tablet were placed in the predetermined sites. Subsequently, the apparatus was evacuated using a combination of a diffusion pump and cryo coil to reach 1×10⁻³ Pa.

In the apparatus, the substrate was heated to 200° C. by means of a sheathed heater. An electron beam from an electron gun (accelerating voltage: 4.0 kV) was applied onto each tablet so as to deposit stimulable CsBr:Eu phosphor on the substrate at a deposition rate of 10 μm/min. In this procedure, the emission current for each electron gun was so controlled that a molar concentration ratio of Eu/Cs in the deposited phosphor layer would be 0.003/1. The surrounding gas atmosphere was mass-spectroscopically analyzed to indicate that a partial pressure of water was 4.0×10⁻³ Pa.

After the evaporation-deposition was complete, the inner pressure was returned to atmospheric pressure, and the substrate was taken out of the apparatus. The quartz substrate having the deposited phosphor film was placed on a quartz boat and heated at 200° C. for 2 hours in the center of a tube furnace under nitrogen gas atmosphere. Before and during the heat treatment, the center of the tube furnace was evacuated by means of a rotary pump to reach approx. 10 Pa, so that water adsorbed on the deposited film would be removed. Subsequently, the substrate and the deposited film was cooled in vacuo and the cooled substrate was then taken out of the tube furnace. On the substrate, a deposited film (thickness: approx. 400 μm, area: 10 cm×10 cm) consisting of prismatic phosphor crystals aligned densely and perpendicularly was formed.

Thus, a radiation image storage panel of the invention having a substrate and a deposited phosphor layer was prepared.

### EXAMPLE 2

(1) Starting Materials

The same starting materials as those used in Example 1 were employed.

(2) Preparation of CsBr Evaporation Source

The powdery CsBr (32 g) was placed in a platinum crucible (inner diameter: 25 mm) and heated at 700° C. for 30 minutes to fuse under nitrogen gas atmosphere. The fused CSBr was then cooled to room temperature, to produce a tablet (diameter: 25 mm, thickness: 15 mm). The produced tablet had a density of 4.4 g/cm³, and a water content of 0.1 wt. %.

(3) Preparation of EuBrₓ Evaporation Source

The powdery EuBrₓ (x=2.2, 26 g) was placed in a platinum crucible (inner diameter: 25 mm) and heated at 800° C. for 30 minutes to fuse under nitrogen gas atmosphere. The fused EuBrₓ was then cooled to room temperature, to produce a tablet (diameter: 25 mm, thickness: 10 mm)). The produced tablet had a density of 5.3 g/cm³, and a water content of 0.3 wt. %.

(4) Formation of Phosphor Film

The evaporation-deposition procedure was repeated in the same manner as in Example 1 to produce on a substrate a deposited film (thickness: approx. 400 μm, area: 10 cm×10 cm) consisting of prismatic phosphor crystals aligned densely and perpendicularly was formed. Thus, a radiation image storage panel of the invention having a substrate and a deposited phosphor layer was prepared.

### COMPARISON EXAMPLE 1

(1) Starting Materials

The same starting materials as those used in Example 1 were employed.

(2) Preparation of CsBr Evaporation Source

The procedure of Example 1 was repeated to produce a CsBr tablet having a density of 4.2 g/cm³, and a water content of 0.3 wt. %.

(3) Preparation of EuBrₓ Evaporation Source

A powdery EuBrₓ (x=2.2, 25 g) was placed in a powder moulding zirconia die and compressed at a pressure of 40 kN, to produce a tablet (diameter: 25 mm, thickness; 10 mm). The pressure applied to the powdery EuBrₓ was approx. 80 MPa. The produced tablet had a density of 5.1 g/cm³, and a water content of 0.8 wt. %.

(4) Formation of Phosphor Film

The evaporation-deposition procedure of Example 1 was repeated to produce on a substrate a deposited film (thickness: approx. 400 μm, area: 10 cm×10 cm) consisting of prismatic phosphor crystals aligned densely and perpendicularly was formed. Thus, a radiation image storage panel for comparison having a substrate and a deposited phosphor layer was prepared.

### COMPARISON EXAMPLE 2

(1) Starting Materials

The same starting materials as those used in Example 1 were employed.

(2) Preparation of CsBr Evaporation Source

A powdery CsBr (31 g) was placed in a powder moulding zirconia die and compressed at a pressure of 40 kN, to produce a tablet (diameter: 25 mm, thickness: 10 mm). The pressure applied to the powdery CsBr was approx. 80 MPa. The produced tablet had a density of 4.2 g/cm³, and a water content of 0.6 wt. %.

(3) Preparation of EuBrₓ Evaporation Source

The procedure of Example 1 was repeated to produce a EuBrₓ tablet having a density of 5.1 g/cm³, and a water content of 0.5 wt. %.

(4) Formation of Phosphor Film

The evaporation-deposition procedure of Example 1 was repeated to produce on a substrate a deposited film (thickness: approx. 400 μm, area: 10 cm×10 cm) consisting of prismatic phosphor crystals aligned densely and perpendicularly was formed. Thus, a radiation image storage panel for comparison having a substrate and a deposited phosphor layer was prepared.

### Evaluation of Radiation Image Storage Panel-1

The radiation image storage panels were examined in the conditions of their prismatic phosphor crystals and unevenness of emission in the following manner.

(1) Conditions of Prismatic Phosphor Crystals

The phosphor layer and substrate of the radiation image storage panel were simultaneously sectioned in the depth direction. The section was covered with gold (thickness: 300 angstroms) by ion sputtering, to keep it from charge-up. Subsequently, the surface and section of the phosphor layer were observed by means of a scanning electron microscope (JSM-5400, Japan Electron Co., Ltd.).

(2) Unevenness of Emission

The radiation image storage panel was encased in a light-shielding cassette. To the radiation image storage panel were applied X-rays which was emitted at a voltage 40 kVP and a current of 16 mA. Subsequently, the storage panel was taken out of the cassette and was scanned with He—Ne laser beam (wavelength: 633 nm), and the stimulated emission was detected by a photomultiplier. The detected luminance signals were detected and printed on a radiographic film with a laser printer. The printed image was visually ed.

The results are set forth in Table 1.

TABLE 1

| | Water content of Tablet | | Conditions | Unevenness |
|---|---|---|---|---|
| | CsBr | EuBrₓ | of prismatic | of |
| Example | (wt. %) | (wt. %) | crystals | emission |
| Example 1 | 0.2 | 0.5 | Good | Almost none |
| Example 2 | 0.1 | 0.3 | Good | None |
| Com. Ex. 1 | 0.3 | 0.8 | Bad | Observed |
| Com. Ex. 2 | 0.6 | 0.5 | Relatively | Portionwise |
| | | | bad | observed |

### EXAMPLE 3

The procedures of Example 1 were repeated except that the evaporation apparatus was evacuated by means of a combination of a diffusion pump and cryo coil to have a partial pressure of water content of 6.7×10⁻³ Pa, and the deposition rate was changed to 20 μm/min., to prepare a radiation image storage panel of the invention having a substrate and a deposited phosphor layer.

### EXAMPLE 3a

The procedures of Example 1 were repeated except that the evaporation apparatus was evacuated by means of a combination of a diffusion pump and cryo coil to have a vacuum level of 5×10⁻⁴ Pa and a partial pressure of water content of 1.8×10⁻³ Pa, to prepare a radiation image storage panel of the invention having a substrate and a deposited phosphor layer.

### EXAMPLE 3b

The procedures of Example 1 were repeated except that the evaporation apparatus was evacuated by means of a combination of a diffusion pump and cryo coil to have a vacuum level of 5×10⁻⁴ Pa and a partial pressure of water content of 2.3×10⁻³ Pa after introducing Ar gas to change the vacuum level to 1×10⁻³ Pa, to prepare a radiation image storage panel of the invention having a substrate and a deposited phosphor layer.

### COMPARISON EXAMPLE 3

The procedures of Example 1 were repeated except that the evaporation apparatus was evacuated by means of a diffusion pump only to have a partial pressure of water content of 8.0×10⁻³ Pa., to prepare a radiation image storage panel for comparison having a substrate and a deposited phosphor layer.

### COMPARISON EXAMPLE 4

The procedures of Example 1 were repeated except that the evaporation apparatus was evacuated by means of a diffusion pump only to have a partial pressure of water content of 1.2×10⁻² Pa., and the deposition rate was changed to 20 μm/min., to prepare a radiation image storage panel for comparison having a substrate and a deposited phosphor layer.

### Evaluation of Radiation Image Storage Panel-2

The radiation image storage panels were examined in the conditions of their prismatic phosphor crystals and unevenness of emission in the manner described hereinbefore. The results are set forth in Table 2.

TABLE 2

| | Apparatus | Partial | Conditions | Unevenness |
|---|---|---|---|---|
| | for | pressure of | of prismatic | of |
| Example | Evacuation | water (Pa) | crystals | emission |
| Example 1 | DP + CC | 4.0 × 10⁻³ | Good | Almost none |
| Example 3 | DP + CC | 6.7 × 10⁻³ | Good | Almost none |
| Example 3a | DP + CC | 1.8 × 10⁻³ | Good | Almost none |
| Example 3b | DP + CC | 2.3 × 10⁻³ | Good | Almost none |
| Com. Ex. 3 | DP | 8.0 × 10⁻³ | Relatively | Portionwise |
| | | | bad | observed |
| Com. Ex. 4 | DP | 1.2 × 10⁻² | Relatively | Observed |
| | | | bad | |

Remarks:
DP means diffusion pump, CC means cryo coil.
Sensitivity values:
100 for Ex. 1, 85 for Ex. 3, 160 for Ex. 3a, and 140 for Ex. 3b

### EXAMPLE 4

(1) Starting Materials

Powdery cesium bromide (CsBr, purity: 5N or higher) and powdery europium bromide (EuBrₓ, x=2.2, purity: 3N or higher) were employed as the starting materials. The analysis of each starting material by ICP-MS method revealed that each of alkali metals other than Cs (Li, Na, K, Rb) and each of alkaline earth metals (Mg, Ca, Sr, Ba) were present in the cesium bromide in amounts of less than 10 ppm and less than 5 ppm, respectively, and each of rare earth elements other than Eu and other elements were present in the europium bromide in amounts of less than 20 ppm and less than 10 ppm, respectively.

Since both starting materials were highly hygroscopic, they were stored in a desiccator under dry atmosphere showing a dew point of lower than −20° C., and taken out just before the following preparation was made.

(2) Preparations of Evaporation Sources and Formation of Phosphor Film

Each of CsBr tablet and EuBrₓ tablet was prepared in the same manner as stated in Example 1, and CsBr:0.01Eu phosphor layer was formed on a quartz substrate in the same manner as described in Example 1, to prepare a radiation image storage panel of the invention having a substrate and a deposited phosphor layer.

The contents of impurity elements in the CsBr evaporation source are set forth in Table 3, and the contents of impurity elements in the deposited phosphor film are set forth in Table 4.

### EXAMPLE 5

(1) Starting Materials

The same starting materials as those used in Example 4 were employed.

(2) Preparations of evaporation Sources and Formation of Phosphor Film

The powdery CsBr (30 g, 0.14 mol) and powdery EuBrₓ (x=2.2, 0.46 g, 0.0014 mol) were mixed in a mixer. The resulting mixture was placed in a quartz vessel and inserted into the center of an electric furnace. First, the electric furnace was evacuated and then a nitrogen gas was introduced into the furnace to reach atmospheric pressure. In the furnace, the mixture was fired at 525° C. for one hour. Subsequently, the furnace was evacuated for 5 minutes, and an oxygen gas was introduced into the furnace to reach 133 Pa. Then, a nitrogen gas was further introduced to reach atmospheric pressure, and the once fired mixture was again fired for one hour. After the firing was complete, the mixture was cooled to room temperature in vacuo. The resulting CsBr:0.01Eu phosphor contained the impurities in almost the same amounts as in the CsBr starting materials.

The obtained CsBr:0.01Eu phosphor was processed in the same manner as in Example 1 to prepare a tablet. The tablet had a density of 4.1 g/cm³ and a water content of 0.4 wt. %.

(3) Formation of Phosphor Film

The procedure of Example 1 was repeated using one tablet prepared above, to prepare a radiation image storage panel of the invention having a substrate and a deposited phosphor layer.

### COMPARISON EXAMPLES 5 & 6

The procedures of Example 4 were repeated except for using a CsBr starting material which had impurity contents set forth in Table 3, to prepare a radiation image storage panel for comparison having a substrate and a deposited phosphor layer.

### COMPARISON EXAMPLES 7 & 8

The procedures of Example 5 were repeated except for using a CsBr starting material which had impurity contents set forth in Table 3, to prepare CsBr:0.01Eu phosphor, and finally to prepare a radiation image storage panel for comparison having a substrate and a deposited phosphor layer.

TABLE 3

| | Impurity content (ppm) of CsBr starting material | | | | | | | |
|---|---|---|---|---|---|---|---|---|
| | Li | Na | K | Rb | Mg | Ca | Sr | Ba |
| Examples | 1.5 | 3.2 | 5.4 | 7.2 | 0.6 | 1.2 | 1.5 | 2.1 |
| 4 & 5 | | | | | | | | |
| Com. Ex. | 3.4 | 60 | 270 | 65 | 1.2 | 4 | 3 | 7.5 |
| 5 & 7 | | | | | | | | |
| Com. Ex. | 2.7 | 95 | 220 | 1500 | 1.3 | 3 | 2 | 12 |
| 6 & 8 | | | | | | | | |

TABLE 4
Impurity content (ppm) of deposited phosphor film

| | Li | Na | K | Rb |
|---|---|---|---|---|
| Examples | <0.5 | <0.5 | <1 | 2 |
| 4 & 5 | | | | |
| Com. Ex. | <0.5 | 10 | 30 | 15 |
| 5 & 7 | | | | |
| Com. Ex. | <0.5 | 18 | 27 | 150 |
| 6 & 8 | | | | |

Remarks:
The alkaline earth metal impurity contents were less than the limits of measurement.

### Evaluation of Radiation Image Storage Panel-3

The radiation image storage panels were examined in their sensitivity by the following method.

The radiation image storage panel was encased in a light-shielding cassette. To the radiation image storage panel were applied X-rays which was emitted at a voltage 40 kVP and a current of 16 mA. Subsequently, the storage panel was taken out of the cassette and was scanned with He—Ne laser beam (wavelength: 633 nm), and the stimulated emission was detected by a photomultiplier. The detected stimulated emissions were then converted into sensitivity values. The results are set forth in Table 5 in which the values are expressed in terms of a relative value (standard is a value measured on the storage panel of Example 4).

TABLE 5

| Example | Evaporation mode | Relative sensitivity |
|---|---|---|
| Example 4 | Two pellet evaporation | 100 |
| Com. Ex. 5 | Two pellet evaporation | 62 |
| Com. Ex. 6 | Two pellet evaporation | 54 |
| Example 5 | One pellet evaporation | 69 |
| Com. Ex. 7 | One pellet evaporation | 51 |
| Com. Ex. 8 | One pellet evaporation | 46 |

The emission strength of stimulated emission measured on each of CsBr:0.01Eu phosphors obtained in Example 5, Comparison Example 7 and Comparison Example 8 are set forth in Table 6.

TABLE 6

| Example | Relative strength of stimulated emission |
|---|---|
| Example 5 | 100 |
| Com. Ex. 7 | 7.1 |
| Com. Ex. 8 | 2.9 |

### EXAMPLE 6

(1) Starting Materials

The same starting materials as those used in Example 1 were employed.

(2) Preparation of CsBr Evaporation Source

The procedure of Example 1 was repeated to produce a CsBr tablet having a density of 4.2 g/cm³, and a water content of 0.3 wt. %.

(3) Preparation of EuBrₓ Evaporation Source

The procedure of Example 1 was repeated to produce a EuBrₓ tablet having a density of 5.1 g/cm³, and a water content of 0.5 wt. %.

(4) Formation of Phosphor Film

The inner members of an evaporation apparatus was washed successively with acetone, isopropyl alcohol, purified water and an aqueous surfactant solution, and baked by means of sheathed heater. A synthetic quartz substrate was washed successively with an aqueous alkaline solution, purified water, and isopropyl alcohol, and then mounted to a substrate holder within an evaporation apparatus. In the apparatus, the CsBr tablet and EuBrₓ tablet were placed in the predetermined sites. Subsequently, the apparatus was evacuated using a combination of a diffusion pump and cryo coil to reach 5×10⁻⁴ Pa.

In the apparatus, the substrate was heated to 200° C. by means of a sheath heater. An electron beam from an electron gun (accelerating voltage: 4.0 kV) was applied onto each tablet for 40 min. so as to deposit stimulable CsBr:Eu phosphor on the substrate at a deposition rate of 10 μm/min. In this procedure, the emission current for each electron gun was so controlled that a molar concentration ratio of Eu/Cs in the deposited phosphor layer would be 0.003/1. The surrounding gas atmosphere was mass-spectroscopically analyzed to indicate that a partial pressure of water was 1.8×10⁻³ Pa and a partial pressure of hydrocarbon (HC) was 8×10⁻⁷ Pa.

After the evaporation-deposition was complete, the quartz substrate was heated in the same manner as in Example 1. On the substrate, a deposited film (thickness; approx. 400 μm, area: 10 cm×10 cm) consisting of prismatic phosphor crystals aligned densely and perpendicularly was formed.

Thus, a radiation image storage panel of the invention having a substrate and a deposited phosphor layer was prepared.

### EXAMPLE 9

The procedures of Example 8 were repeated except for that the apparatus was evacuated to have a vacuum level of 5×10⁻⁴ Pa and subsequently to have a vacuum level of 1×10⁻³ Pa after introduction of Ar gas. The partial pressures of water and HC were 2.3×10⁻³ Pa and 9×10⁻⁷ Pa, respectively.

### COM. EX. 9

The procedures of Example 8 were repeated except for that the apparatus was evacuated to have a vacuum level of 1×10⁻³ Pa. The partial pressures of water and HC were 4.0×10⁻³ Pa and 2×10⁻⁶ Pa, respectively.

### COM. EX. 10

The procedures of Example 8 were repeated except for that the washing of the inner members of the evaporation apparatus was made only with acetone. The partial pressures of water and HC were 51.8×10⁻³ Pa and 5×10⁻⁶ Pa, respectively.

### Evaluation of Radiation Image Storage Panel-4

The radiation image storage panels were examined in the conditions of their prismatic phosphor crystals, unevenness of emission, and sensitivity in the manner described hereinbefore. The results are given in Table 7.

TABLE 7

| Example | Sensitivity (Relative value) |
|---|---|
| Example 8 | 115 |
| Example 9 | 100 |
| Com. Ex. 9 | 70 |
| Com. Ex. 10 | 40 |

What is claimed is:

1. A method for preparing a radiation image storage panel by heating an evaporation source comprising phosphor material or starting materials for the phosphor material under reduced pressure to produce a vapor of the phosphor material or starting materials and deposit the vapor on a substrate to form a phosphor layer thereon, wherein the evaporation source has a water content of not more than 0.5 weight %.

2. The method of claim 1, wherein the evaporation source has a relative density of not less than 80%.

3. The method of claim 1, wherein the evaporation source is prepared by compressing a powdery mixture of the phosphor material or starting material and heating the compressed powder mixture under reduced pressure.

4. The method of claim 1, wherein the evaporation source is prepared by heating the phosphor material or starting material until it fuses.

5. The method of claim 1, wherein the evaporation source comprises an evaporation source of a mother component containing of the phosphor and an evaporation source containing an activating element of the phosphor.

6. The method of claim 1, wherein the production and deposition of vapor are performed at a partial pressure of water of 7.0×10⁻³ Pa or lower.

7. The method of claim 1, wherein the production and deposition of vapor are performed at a partial pressure of hydrocarbon of 1.0×10⁻⁶ Pa or lower.

8. The method of claim 1, wherein the phosphor is a stimulable phosphor.

9. The method of claim 8, wherein the stimulable phosphor comprises an alkali metal halide phosphor having the formula (I):
M^{I}X.aM^{II}X′₂.bM^{III}X″₃:zA (I)
in which M^{I} is at least one alkali metal element selected from the group consisting of Li, Na, K, Rb and Cs; M^{II} is at least one alkaline earth metal element or divalent metal element selected from the group consisting of Be, Mg, Ca, Sr, Pa, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ independently is at least one halogen selected from the group consisting of F, Cl, Br and I; A is at least one rare earth element or metal element selected from the group consisting of Y, Ce, Pr, Nd, Sm, Eu, Gd, Tb, Dy, Ho, Er, Tm, Yb, Lu, Na, Mg, Cu, Ag, Tl and Bi; and a, b and z are numbers satisfying the conditions of 0≦a<0.5, 0≦b<0.5 and 0<z<1.0, respectively.

10. The method of claim 9, wherein the evaporation source contains not more than 10 ppm of alkali metal impurities and not more than 5 ppm of alkaline earth metal impurities, the alkali metal impurities and alkaline earth metal impurities meaning alkali metals and alkaline earth metals other than the alkali metals and alkaline earth metals constituting the alkali metal halide phosphor of the formula (I) in the evaporation source.

11. A radiation image storage panel having a phosphor layer formed by vapor deposition, wherein the phosphor layer compress an alkali metal halide phosphor having the formula (I):
M^{I}X.aM^{II}X′₂.bM^{III}X″₃:zA (I)
in which M^{I} is at least one alkali metal element selected from the group consisting of Li, Na, K, Rb and Cs; M^{II} is at least one alkaline earth metal element or divalent metal element selected from the group consisting of Be, Mg, Ca, Sr, Ba, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ independently is at least one halogen selected from the group consisting of F, Cl, Br and I; A is at least one rare earth element or metal element selected from the group consisting of Y, Ce, Pr, Nd, Sm, Eu, Gd, Tb, Dy, Ho, Er, Tm, Yb, Lu, Na, Mg, Cu, Ag, Tl and Bi; and a, b and z are numbers satisfying the conditions of 0≦a≦0.5, 0≦b<0.5 and 0<z<1.0, respectively, and the phosphor layer contains not more than 10 ppm of alkali metal impurities and not more than 5 ppm of alkaline earth metal impurities, the alkali metal impurities and alkaline earth metal impurities meaning alkali metals and alkaline earth metals other than the alkali metals and alkaline earth metals constituting the alkali metal halide phosphor of the formula (I) in the phosphor layer.

12. A method for preparing a radiation image storage panel by heating a evaporation source comprising phosphor material or starting materials for the phosphor material under reduced pressure to produce a vapor of the phosphor material or starting materials and deposit the vapor on a substrate to form a phosphor layer thereon, wherein the production and deposition of vapor are performed at a partial pressure of water of 7.0×10⁻³ Pa or lower.

13. The method of claim 12, wherein the partial pressure of water is 3.0×10⁻³ Pa or lower.

14. The method of claim 12, wherein the production and deposition of vapor are performed at a partial pressure of hydrocarbon of 1.0×10⁻⁶ Pa or lower.

15. The method of claim 12, wherein the phosphor is a stimulable phosphor.

16. The method of claim 15, wherein the stimulable phosphor comprises an alkali metal halide phosphor having the formula (I):
M^{I}X.aM^{II}X′₂.bM^{III}X″₃:zA (I)
in which M^{I} is at least one alkali metal element selected from the group consisting of Li, Na, K, Rh and Cs; M^{II} is at least one alkaline earth metal element or divalent metal element selected from the group consisting of Be, Mg, Ca, Sr, Ba, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ independently is at least one halogen selected from the group consisting of F, Cl, Br and I; A is at least one rare earth element or metal element selected from the group consisting of Y, Ce, Pr, Nd, Sm, Eu, Gd, Tb, Dy, Ho, Er, Tm, Yb, Lu, Na, Mg, Cu, Ag, Tl and Si; and a, b and z are numbers satisfying the conditions of 0≦a<0.5, 0≦b<0.5 and 0<z<1.0, respectively.

17. A method for preparing a radiation image storage panel by heating a evaporation source comprising phosphor material or starting materials for the phosphor material under reduced pressure to produce a vapor of the phosphor material or starting materials and deposit the vapor on a substrate to form a phosphor layer thereon, wherein the production and deposition of vapor are performed at a partial pressure of hydrocarbon of 1.0×10⁻⁶ Pa or lower.

18. The method of claim 17, wherein the phosphor is a stimulable phosphor.

19. The method of claim 18, wherein the stimulable phosphor comprises an alkali metal halide phosphor having the formula (I):
M^{I}X.aM^{II}X′₂.bM^{III}X″₃:zA (I)
in which M^{I} is at least one alkali metal element selected from the group consisting of Li, Na, K, Rb and Cs; M^{II} is at least one alkaline earth metal element or divalent metal element selected from the group consisting of Be, Mg, Ca, Sr, Ba, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ independently is at least one halogen selected from the group consisting of F, Cl, Br and I; A is at least one rare earth element or metal element selected from the group consisting of Y, Ce, Pr, Nd, Sm, Eu, Gd, Tb, Dy, Ho, Er, Tm, Yb, Lu, Na, Mg, Cu, Ag, Tl a Bi; and a, b and z are numbers satisfying the conditions of 0≦a<0.5, 0≦b<0.5 and 0<z<1.0, respectively.
